(19) United States
(12) Patent Application Publication
(10) Pub. No.: US 2010/0187078 A1
(43) Pub. Date: Jul. 29, 2010

(54) LIGHT GUIDE PLATE AND APPLIED KEYPAD THEREOF

(75) Inventor: Yi-Song Bai, Guangdong (CN)

Correspondence Address: Dr. BANGER SHIA;Patent Office of Bang Shia, 102 Lindencrest Ct., Sugar Land, TX, 77479-5201, US

(73) Assignees: Dongguan Memtech Electronic Products Co. Ltd.; Memtech International Co., Ltd.

(21) Appl. No.: 12/668,883

(22) PCT Filed: Jul. 16, 2007
(86) PCT No.: PCT/CN07/02166

§ 371 Date: Jan. 13, 2010

(51) Int. Cl. H01H 9/00

(52) U.S. Cl. 200/314

(57) ABSTRACT

A light guide plate and applied keypad thereof are provided. The light guide plate comprises a high transmittance plastic plate body (10). Multiple projections (12) formed by the light solidity colloid material are set on the upper surface (11) of the plastic plate body (10), and the printing ink layers (14) corresponding to the projections (12) seriatim and serving the function of the light guide are set on the undersurface (13) of the plastic plate body (10). By setting the projections (12) on the plastic plate body (10) of the light guide plate, the keypad using the light guide plate can make the projections (12) direct true to the projecting switches (31) of the cardinal plate (30) such that different forms of the key structures can be selected to match.

### BACKGROUND OF THE INVENTION

1. Field of the Invention

The present invention relates to a light guide plate and applied keypad thereof, in particular to one applying to electrical and communicating products like the keyboard or keypad on cellular/mobile phones or domestic appliances.

2. Description of the Related Art

A conventional keyboard adapted to mobile phones as shown in FIG. 1 comprises a key 1′, a light guide plate 2′, and a principle plate 3′; wherein, the light guide plate 2′ is located between the key 1′ and the principle plate 3′ for perviousness to light; the principle plate 3′ forms a plurality of projecting switches 31′ thereon; the typical light guide plate 2′ is commonly fabricated by a plastic material and provided with two glossy and flat surfaces. Further, the key 1′ has multiple projections 11′ facing the light guide plate 2′ and located relatively to the projecting switches 31′ of the principle plate 3′ in sequence for thence triggering the switches 31′. In case of assembling, the problems attendant with the compartment of the light guide plate 2′ between the key 1′ and the principle plate 3′ may raise the difficulty in aligning the projecting switches 31′ with the projections 11′ and thus incur the defective production as well as low manufacturing efficiency due to longer working time. As it is, the light guide plate 2′ possessing two glossy surfaces inevitably restricts the adapted shapes of the key 1′, for instance of one with flat surfaces can not be suitable in this case. Thus, the conventional invention still needs improvements.

### SUMMARY OF THE INVENTION

Therefore, the object of the present invention is to solve the aforementioned problems and to provide a light guide plate and relevant keypad thereof which essentially applies projections formed on the light guide plate to facilitate the installation of the keypad and so permissibly match with an assortment of key structures.

Accordingly, a light guide plate in accordance with the present invention comprises a plastic plate body with high transmittance; wherein, on an upper surface of the plastic plate body forms a plurality of projections made of a light solidity colloid material; and suitably on an undersurface of the plastic plate body disposes a plurality of printing ink layers that correspond to the projections seriatim for functioning as light guide.

A keypad made by the light guide plate as mentioned supra comprises a key, a light guide plate and a cardinal plate; wherein, the light guide plate is disposed between the key and the cardinal plate, the cardinal plate has a plurality of projecting switches defined thereon, and the light guide plate has a plastic plate body with high transmittance. Characterized in that, a plurality of projections made of a light solidity colloid material are formed on an upper surface of the plastic plate body and located true to the projecting switches, and a plurality of printing ink layers, corresponding to the projections seriatim for functioning as light guide, are disposed on an undersurface of the plastic plate body. Preferably, the key has multiple keycaps disposed thereon and defines a flat surface facing the light guide plate.

By comparing with the conventional technique, the present invention takes advantage of the projections on the plastic plate body of the light guide plate to precisely and directly align each projection with each matched projecting switch of the cardinal plate. Thus, the present concatenation of interrelated elements is substantially allowed adapting with a key structure in various formations, especially with one having a flat bottom. Moreover, the present configuration also prevents the malposition between the projections on the key and the projecting switches of the cardinal plate and also reduces working time, thereby efficiently streamlining the assemblage and increasing the assembling efficiency.

### BRIEF DESCRIPTION OF THE DRAWINGS

FIG. 1 is a schematic view showing a conventional keypad;

FIG. 2 is schematic view showing a light guide plate of the present invention; and

FIG. 3 is a schematic view showing the combination of a keypad and the light guide plate in accordance with the present invention.

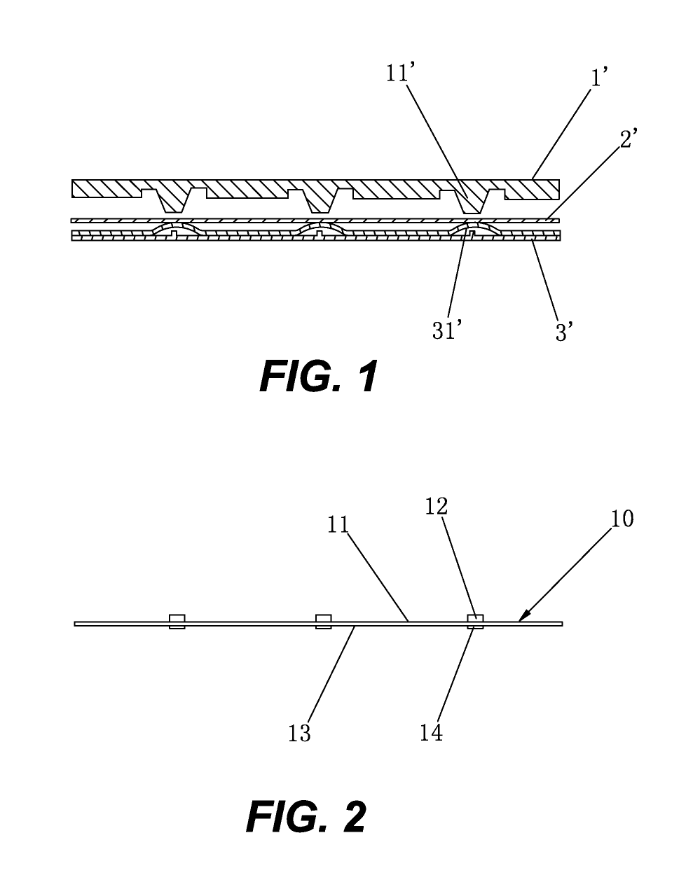

### DETAILED DESCRIPTION OF THE PREFERRED EMBODIMENTS

The advantages of the present invention over the known prior arts will become more apparent to those of ordinary skilled in the art by reading the following descriptions with relating drawings.

Referring to FIG. 2, a light guide plate in accordance with the present invention comprises a plastic plate body 10, and the plastic plate body 10 could be manufactured by an injection of a plastic stuff with high transmittance into a related mold or merely by a cutting of a complete plastic sheet with high transmittance.

Wherein, on an upper surface 11 of the plastic plate body 10 forms a plurality of projections 12 made of a light solidity colloid material. The method for shaping the projections 12 is to pour the light solidity colloid material into molding holes on a mold, then set the plastic plate body 10 upon the molding holes, ensue a pressing and a lightly solidifying procedures, and thence release from the mold. Suitably, on an undersurface 13 of the plastic plate body 10 disposes a plurality of printing ink layers 14 that correspond to the projections 12 seriatim and preferably enhances the light guidance of the plastic plate body 10. It is not restricted to the layers made by silk screen printing or pad printing.

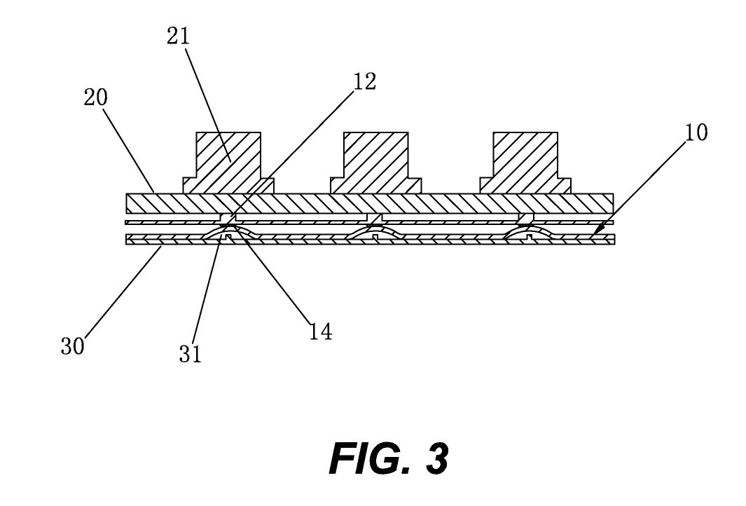

Further referring to FIG. 3, a keypad made by the light guide plate as mentioned supra comprises the aforementioned light guide plate, a key 20 with keycaps 21 disposed thereon, and a cardinal plate 30.

Wherein, the light guide plate is disposed between the key 20 and the cardinal plate 30, and the cardinal plate 30 provides with a plurality of projecting switches 31 defined thereon. The light guide plate adopts a plastic plate body 10 with high transmittance, on an upper surface 11 of which a plurality of projections 12 made of a light solidity colloid material are formed. The projections 12 respectively correspond and substantially align with respect to the locations of projecting switches 31 on the cardinal plate 30. Further, a plurality of printing ink layers 14 are disposed suitably to the projections 12 seriatim for directly contacting with the projecting switches 31. The key 20 has a flat surface facing the light guide plate. Accordingly, a downward compression impinges on projections 12 of the light guide plate that ensued from the pressing of the key 20 and permits the projections 12 to activate the projecting switches 31 of the cardinal plate 30.

In addition, it is also preferably to arrange multiple projecting portions at an undersurface of the key 20 for leaning against the projections 12 of the light guide plate in sequence, so as to render the alignment of the projecting portions with the projections 12. Accordingly, the projecting portions impact on the projections 12 of the light guide plate and permit the projections 12 to activate the projecting switches 31 of the cardinal plate 30.

To sum up, the present invention takes advantage of the projections on the plastic plate body of the light guide plate to directly align each projection with each matched projecting switch of the cardinal plate. Thus, the present configuration could substantially adapt to a key structure in different formations, in particular to one having a flat bottom. The present configuration also prevents the malposition among the projections on the key and the projecting switches of the cardinal plate and also reduces working time, thereby efficiently streamlining the assemblage and increasing the assembling efficiency.

While we have shown and described the embodiment in accordance with the present invention, it should be clear to those skilled in the art that further embodiments may be made without departing from the scope of the present invention.

What is claimed is:

1. A light guide plate comprising a plastic plate body with high transmittance; characterized in that a plurality of projections made of a light solidity colloid material being formed on an upper surface of said plastic plate body; a plurality of printing ink layers on an undersurface of said plastic plate body corresponding to said projections seriatim for functioning as light guide.

2. A keypad made by the light guide plate as claimed in claim 1 comprising a key, a light guide plate and a cardinal plate; wherein, said light guide plate being disposed between said key and said cardinal plate, and said cardinal plate having a plurality of projecting switches defined thereon; said light guide plate including a plastic plate body with high transmittance; characterized in that a plurality of projections made of a light solidity colloid material being formed on an upper surface of said plastic plate body for directing true to said projecting switches, respectively; a plurality of printing ink layers on an undersurface of said plastic plate body corresponding to said projections seriatim for functioning as light guide.

3. The keypad as claimed in claim 2, wherein a plurality of keycaps is disposed on said key.

4. The keypad as claimed in claim 2 or 3, wherein said key defines a flat surface facing said light guide plate.
